(19) United States
(12) Patent Application Publication
(10) Pub. No.: US 2026/0054535 A1
(43) Pub. Date: Feb. 26, 2026

(54) VEHICLE TOW HOOKS AND SYSTEMS

(71) Applicants: Hyundai Motor Company, Seoul (KR); Kia Corporation, Seoul (KR)

(72) Inventor: Manikandan Babymony, Superior Township, MI (US)

(21) Appl. No.: 18/815,670

(22) Filed: Aug. 26, 2024

(51) Int. Cl. B60D 1/56; B60D 1/24; B60R 19/34

(52) U.S. Cl. CPC B60D 1/565; B60D 1/243; B60R 19/34

(57) ABSTRACT

A tow hook system is provided. The tow hook system may comprise a bumper beam, a crush box, a fender apron, a front side member, and a tow hook. The tow hook may be coupled to the bumper beam. The crush box may be coupled to the bumper beam opposite the tow hook. The front side member and the fender apron may be coupled to the crush box opposite the bumper beam. The tow hook, the bumper beam, the crush box, the front side member, and the fender apron may be in longitudinal alignment.

### BACKGROUND

### Technical Field

Embodiments of the present disclosure relate to vehicle tow hooks and vehicle tow hook systems and, in particular, to vehicle tow hook connections to a bumper beam, crush box, and front body structure.

### Background

North American pickup trucks generally have a front tow hook permanently mounted to a front of the vehicle. The tow hook increases the rugged appearance of the vehicle, which is preferred by many North American pickup truck purchasers, regardless of any actual use plans for the tow hook. Additionally, many North American pickup truck purchasers want the tow hook to have the full capability of an actual front tow hook even without the actual need for the front tow hook.

Tow hooks are generally used for towing and recovery under off-road conditions. This equipment is essential for customers who do drive off-road. Usually, a front tow hook is mounted to a bumper beam by a pipe welded to it and it can be temporarily screwed in when in use during recovery, but it is not normally maintained mounted in the bumper. However, pickup truck purchasers generally want the tow hooks to be permanently mounted so as to maintain a rugged appearance of the pickup truck.

Current design construction of tow hooks mounted on pickup trucks may not meet the off-road strength and stiffness requirements needed for the tow hooks. For a unibody platform, an attachment needs to be carefully designed to meet the off-road requirements for the tow hook and, at the same time, not affect the crash performance or deformation mode of the front body structure of the vehicle. It is therefore necessary to design front tow hooks to meet off-road requirements without changes to crash performance or deformation modes of front body structures.

For at least these reasons, a tow hook system that meets strength and stiffness requirements for recovery and towing and, at the same time, maintains crash performance of the front body of the vehicle is needed.

### SUMMARY

According to an object of the present disclosure, a tow hook system is provided. The tow hook system may comprise a bumper beam, a crush box, a front side member, and a tow hook. The tow hook may be coupled to the bumper beam. The crush box may be coupled to the bumper beam opposite the tow hook. The front side member may be coupled to the crush box opposite the bumper beam. The tow hook, the bumper beam, the crush box, and the front side member may be in longitudinal alignment.

According to an exemplary embodiment, the tow hook system may comprise one or more bolts and one or more threaded pipe nuts.

According to an exemplary embodiment, the tow hook may be secured to the bumper beam via the one or more bolts and the one or more threaded pipe nuts.

According to an exemplary embodiment, the one or more threaded pipe nuts may be welded to the bumper beam.

According to an exemplary embodiment, the bumper beam, crush box, front side member, and tow hook may be configured to be mounted to a vehicle.

According to an object of the present disclosure, a tow hook system is provided. The tow hook system may comprise a bumper beam, a crush box, a fender apron, a front side member, and a tow hook. The tow hook may be coupled to the bumper beam. The crush box may be coupled to the bumper beam opposite the tow hook. The front side member and the fender apron may be coupled to the crush box opposite the bumper beam. The tow hook, the bumper beam, the crush box, the front side member, and the fender apron may be in longitudinal alignment.

According to an exemplary embodiment, the tow hook system may comprise one or more bolts and one or more threaded pipe nuts.

According to an exemplary embodiment, the tow hook may be secured to the bumper beam via the one or more bolts and the one or more threaded pipe nuts.

According to an exemplary embodiment, the one or more threaded pipe nuts may be welded to the bumper beam.

According to an exemplary embodiment, the bumper beam, crush box, fender apron, front side member, and tow hook may be configured to be mounted to a vehicle.

According to an object of the present disclosure, a tow hook system is provided. The tow hook system may comprise a vehicle, comprising a bumper beam, a crush box, a fender apron, and a front side member. The tow hook system may comprise a tow hook. The tow hook may be coupled to the bumper beam. The crush box may be coupled to the bumper beam opposite the tow hook. The front side member and the fender apron may be coupled to the crush box opposite the bumper beam. The tow hook, the bumper beam, the crush box, the front side member, and the fender apron may be in longitudinal alignment.

According to an exemplary embodiment, the tow hook system may comprise one or more bolts and one or more threaded pipe nuts.

According to an exemplary embodiment, the tow hook may be secured to the bumper beam via the one or more bolts and the one or more threaded pipe nuts.

According to an exemplary embodiment, the one or more threaded pipe nuts may be welded to the bumper beam.

In further aspects, vehicles are provided that comprises a tow hook or tow hook system as disclosed herein.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1A illustrates a perspective view of a plurality of tow hook assemblies mounted to a bumper beam and a crush box of a vehicle, according to an exemplary embodiment of the present disclosure.

FIG. 1B illustrates a perspective view of a plurality of tow hook assemblies mounted to a bumper beam and each tow hook assembly mounted to a respective crush box, according to an exemplary embodiment of the present disclosure.

FIG. 1C illustrates an exploded view of a tow hook assembly, according to an exemplary embodiment of the present disclosure.

FIG. 2A illustrates a strength and stiffness load transfer path of a front perspective view of a tow hook assembly mounted to a bumper beam and a crush box of a vehicle, according to an exemplary embodiment of the present disclosure.

FIG. 2B illustrates a strength and stiffness load transfer path of a side rear perspective view of a tow hook assembly mounted to a bumper beam and a crush box of a vehicle, according to an exemplary embodiment of the present disclosure.

FIG. 3 illustrates an energy absorption load transfer path of an upper view of a tow hook assembly mounted to a bumper beam and a crush box of a vehicle, according to an exemplary embodiment of the present disclosure.

FIG. 4 illustrates bumper beam deformation with alignment of a crush box and a tow hook's outer mounting, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking.” “comparing,” “monitoring,” “calibrating,” “estimating.” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein. In particular aspects, the vehicle suitably may be an SUV or truck, including a pick-up, for example being either or both gasoline-powered and electric-powered.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability: multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Generally, rugged vehicles are configured to withstand harsh elements and enable drivers to maneuver through various weather conditions (e.g., snow, deep water, streams, etc.), terrains (e.g., desert, mud, sand, etc.), and activities (e.g., rock climbing, camping, etc.). Front tow hooks are essential equipment to assist rugged vehicles to maneuver through these weather conditions, terrains, and activities and contribute to the ruggedness of vehicle appearance.

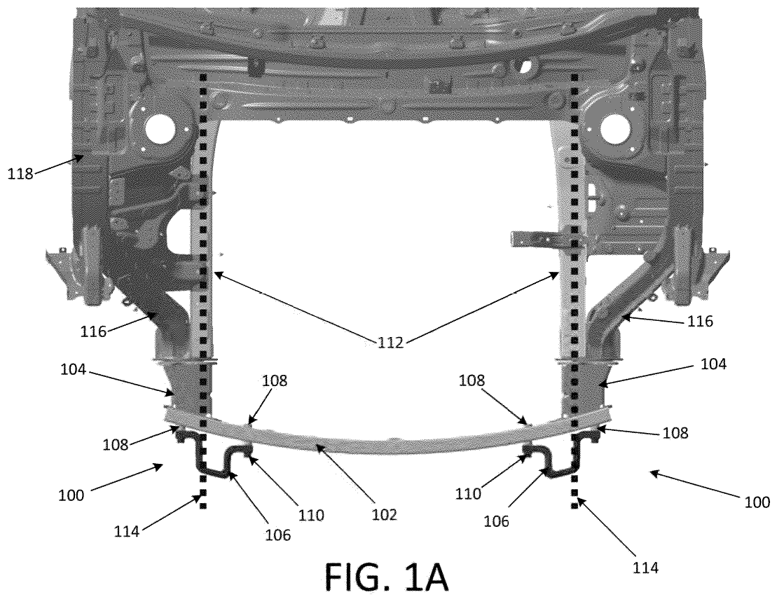

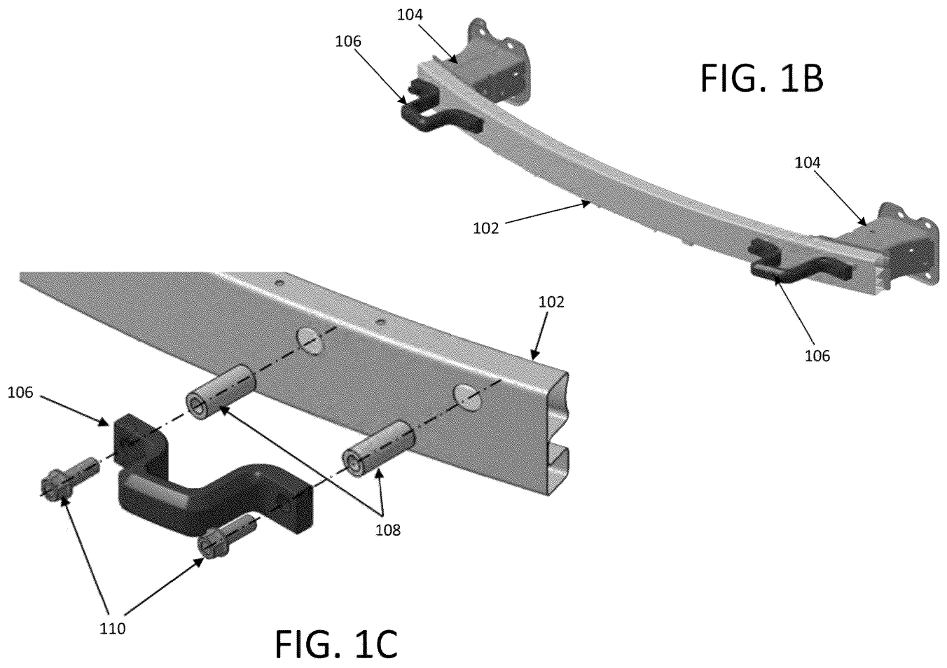

Referring now to FIGS. 1A-1C, a perspective view of a plurality of tow hook assemblies 100 mounted to a bumper beam 102 and a crush box 104 of a vehicle (FIG. 1A), a perspective view of a plurality of tow hook assemblies 100 mounted to a bumper beam 102 and each tow hook assembly 100 mounted to a respective crush box 104 (FIG. 1B), and an exploded view of a tow hook assembly 100 (FIG. 1C) are illustratively depicted, in accordance with exemplary embodiments of the present disclosure. The tow hook assemblies 100 mounted to a bumper beam 102 suitably can be a front bumper component of a vehicle such as for example an SUV or truck including a pick up truck.

According to an exemplary embodiment, the tow hook assembly 100 is a front tow hook assembly. It is noted, however, that the tow hook assembly 100 may be positioned at one or more other positions along a vehicle, while maintaining the spirit and functionality of the of the present disclosure.

According to an exemplary embodiment, the tow hook assembly 100 may be configured to be mounted to a bumper beam 102 and/or a crush box 104 of a vehicle.

According to an exemplary embodiment, the crush box 104 may comprise a welded bracket positioned along and/or coupled to the bumper beam 102. According to an exemplary embodiment, the crush box 104 may be configured to accommodate the mounting of the tow hook assembly 100.

According to an exemplary embodiment, one or more of the tow hook assemblies 100 may comprise a tow hook 106. According to an exemplary embodiment, the tow hook 106 may be configured to be bolted to one or more threaded pipe nuts 108 via one or more bolts 110. According to an exemplary embodiment, the one or more pipe nuts 108 may be welded to the bumper beam 102. The bumper beam may be mounted to the crush box 104. According to an exemplary embodiment, a front side member 112 may be mounted to the crush box 104 opposite the bumper beam 102.

According to an exemplary embodiment, the tow hook's 106 mounting may be longitudinally aligned (e.g., alignment axis 114) with the front body structure, including the crush box 104, front side member 112, and apron upper member 116. Because of this longitudinal alignment, a crash impact to the front tow hook 106 transfers force to the bumper beam 102, crush box 104, front side member 112, and apron upper member 116. This longitudinal transfer of forces from the front tow hook 106, to the crush box 104, the front side member 112, and the apron upper member 116 avoids bending and/or breaking of the bumper beam 102, thus improving the function of the tow hook assembly 100.

The bumper beam 102 not bending and/or breaking from the crash impact prevents changes due to crash deformation. Additionally, this configuration enables both the highly desirable rugged appearance of a permanently mounted front tow hook 106 and reduces the offset load only to the bumper beam 102 as the load is shared share with the crush box 104 and the front side member 112.

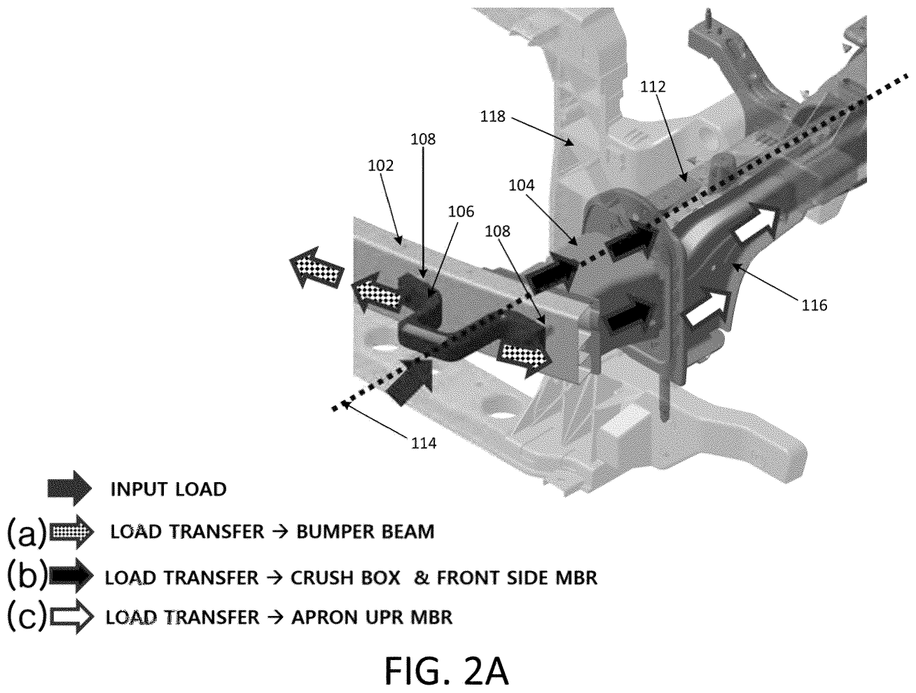

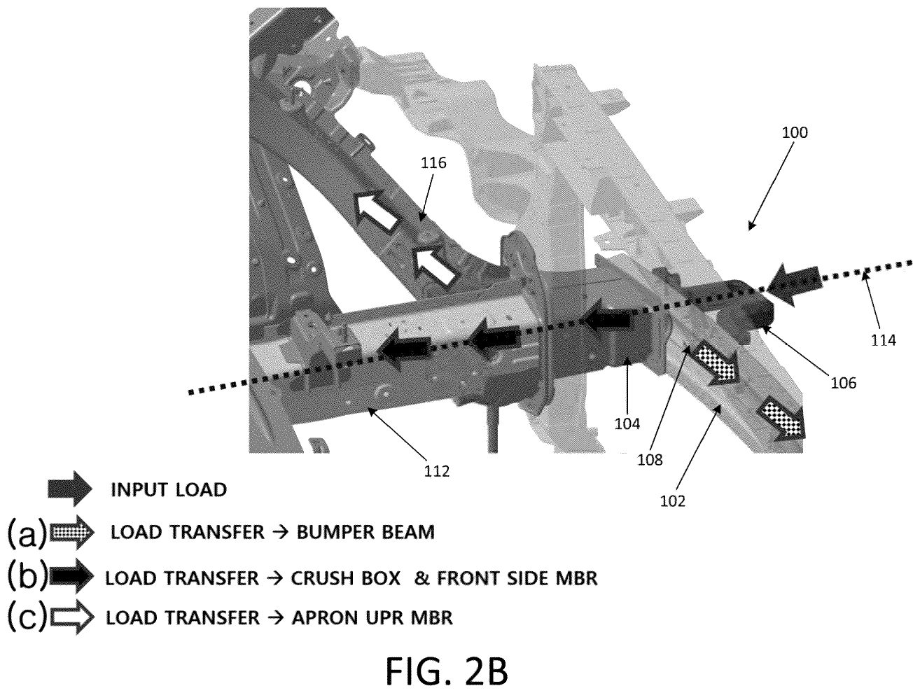

Referring now to FIGS. 2A-2B, a strength and stiffness load transfer path of a front perspective view (FIG. 2A) and a side rear perspective view (FIG. 2B) of a tow hook assembly 100 mounted to a bumper beam 102 and crush box 104 of a vehicle 118 are illustratively depicted, in accordance with an exemplary embodiment of the present disclosure.

The arrangement of the tow hook assembly 100 has at least two primary functions: (1) a towing function; and (2) a front crash mode function.

According to an exemplary embodiment, during loading of the tow hook assembly 100 in a case of recovery and towing (e.g., the towing function), a load, due to tension, compression, and/or slope loading, may get transferred to the bumper beam 102 in an L-direction (as shown, e.g., in arrow (a)—Load Transfer→Bumper Beam). According to an exemplary embodiment, the load path may, at the same time, be transferred to the crush box 104 and front side member 112 of the vehicle 118 in a T-direction (as shown, e.g., in arrow (b)—Load Transfer→Crush Box & Front Side Mbr), causing the input load to displace the vehicle 118 rearwardly, and/or, at the same time, move angularly upward by a fender apron 116 (as shown, e.g., in arrow (c)—Load Transfer→Apron Upr Mbr), causing relatively no deformation of the tow hook assembly 100 from the input load.

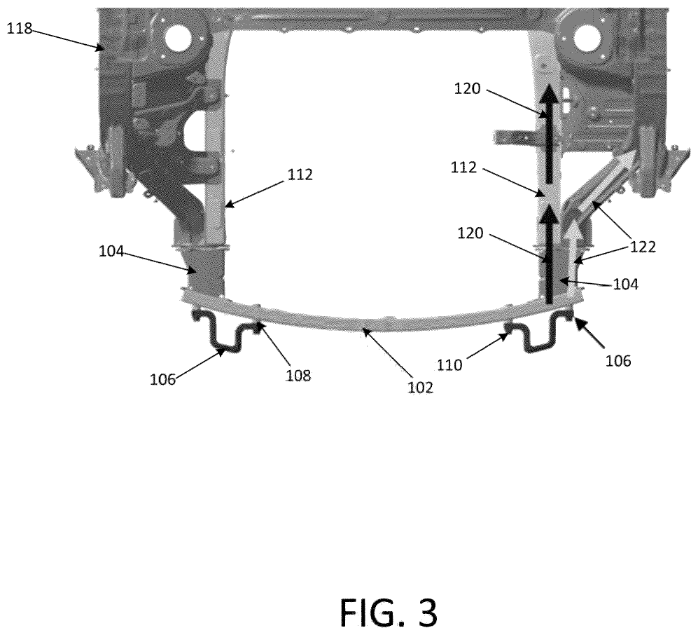

Referring now to FIG. 3, an energy absorption load transfer path of an upper view of a tow hook assembly 100 mounted to a bumper beam 102, a crush box 104, a front side member 112, and an apron upper member 116 is illustratively depicted, in accordance with an exemplary embodiment of the present disclosure.

There are many frontal crash modes requirements for a vehicle 118 body structure during both low speed and high speed crashes in order to help vehicles mitigate damage that may be caused in crashes. Without a tow hook assembly 100, a bumper beam 102, crush box 104, front side member 112, and fender apron 116 are designed to bend and/or deform in a certain way in order to absorb the energy from the crash in the best possible way. These elements work together to achieve optimum results.

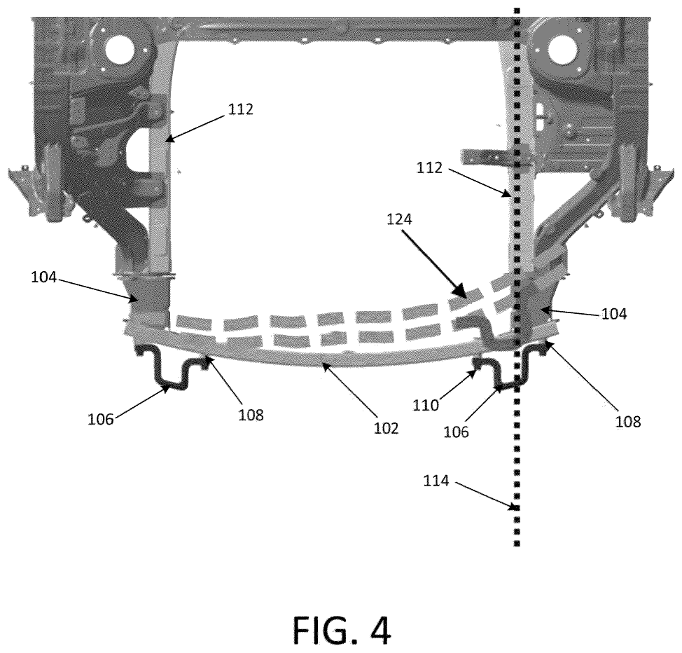

According to an exemplary embodiment, the alignment of the tow hook 106, the bumper beam 102, the crush box 104, the front side member 112, and the fender apron 116 is configured transfer a load along the front side member 112 (along direction 120) and the fender apron 116 (along direction 122), aiding in preventing the breaking and/or bending of the bumper beam 102. According to an exemplary embodiment, the longitudinal alignment is configured to enable the bumper beam 102 to deform according to a desired deformation 124 (as shown, e.g., in FIG. 4).

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including.” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A tow hook system, comprising:
a bumper beam;
a crush box;
a front side member; and
a tow hook,
wherein:
the tow hook is coupled to the bumper beam;
the crush box is coupled to the bumper beam opposite the tow hook;
the front side member is coupled to the crush box opposite the bumper beam; and
the tow hook, the bumper beam, the crush box, and the front side member are in longitudinal alignment.

2. The tow hook system of claim 1, further comprising one or more bolts and one or more threaded pipe nuts.

3. The tow hook system of claim 2, wherein the tow hook is secured to the bumper beam via the one or more bolts and the one or more threaded pipe nuts.

4. The tow hook system of claim 2, wherein the one or more threaded pipe nuts are welded to the bumper beam.

5. The tow hook system of claim 1, wherein the bumper beam, crush box, front side member, and tow hook are configured to be mounted to a vehicle.

6. A tow hook system, comprising:
a bumper beam;
a crush box;
a fender apron;
a front side member; and
a tow hook,
wherein:
the tow hook is coupled to the bumper beam;
the crush box is coupled to the bumper beam opposite the tow hook;
the front side member and the fender apron are coupled to the crush box opposite the bumper beam; and
the tow hook, the bumper beam, the crush box, the front side member, and the fender apron are in longitudinal alignment.

7. The tow hook system of claim 6, further comprising one or more bolts and one or more threaded pipe nuts.

8. The tow hook system of claim 7, wherein the tow hook is secured to the bumper beam via the one or more bolts and the one or more threaded pipe nuts.

9. The tow hook system of claim 7, wherein the one or more threaded pipe nuts are welded to the bumper beam.

10. The tow hook system of claim 6, wherein the bumper beam, crush box, fender apron, front side member, and tow hook are configured to be mounted to a vehicle.

11. A tow hook system, comprising:
a vehicle, comprising:
a bumper beam;
a crush box;
a fender apron; and
a front side member; and
a tow hook,
wherein:
the tow hook is coupled to the bumper beam;
the crush box is coupled to the bumper beam opposite the tow hook;
the front side member and the fender apron are coupled to the crush box opposite the bumper beam; and
the tow hook, the bumper beam, the crush box, the front side member, and the fender apron are in longitudinal alignment.

12. The tow hook system of claim 11, further comprising one or more bolts and one or more threaded pipe nuts.

13. The tow hook system of claim 12, wherein the tow hook is secured to the bumper beam via the one or more bolts and the one or more threaded pipe nuts.

14. The tow hook system of claim 12, wherein the one or more threaded pipe nuts are welded to the bumper beam.

15. A vehicle comprising a tow hook system of claim 1.

16. The vehicle of claim 15 wherein the vehicle is a truck.

17. The vehicle of claim 15 wherein the vehicle is a pick-up truck.
